(19) United States
(12) Patent Application Publication
(10) Pub. No.: US 2011/0314124 A1
(43) Pub. Date: Dec. 22, 2011

(54) CAPTURING AN APPLICATION STATE

(76) Inventor: Roger Brian Gimson, Bristol (GB)

(21) Appl. No.: 13/201,199

(22) PCT Filed: Mar. 25, 2009
(86) PCT No.: PCT/US2009/038230

§ 371 Date: Aug. 11, 2011

(51) Int. Cl. G06F 15/16

(52) U.S. Cl. 709/217

(57) ABSTRACT

A method for capturing an application state includes recognizing that a user has ended or will end an application session at an exit point. In response to the recognizing, an electronic document for depicting state data indicative of the application session and a link for resuming the application session at the exit point is assembled. The electronic document is communicated to the user, providing the user with a record of the data entered so far and allowing the user to subsequently resume the session at the point it was suspended.

### BACKGROUND

Users interact with software applications to perform any number of tasks. Such an application may be provided as a service via the web. Examples include document automation services, photo printing services, ecommerce services, human resource services, and the like. A user's interaction with an application with respect to achieving a particular goal may be thought of as an application session. To complete a session, the user may navigate any number of pages of a given web site. Those pages may even span multiple web sites. Often a user may desire to suspend an application session. Significant time may pass before the user returns to the task. At such time the user would benefit from a reminder of where they last left off—that is—a reminder of the state of the remote application at the time the application session was suspended. Because a reminder is not readily available, the user logs back into the remote application supplying a user name and password and proceeds to navigate through the application to find where they previously left off.

### DRAWINGS

FIG. 1 is a schematic diagram depicting an exemplary environment in which various embodiments may be implemented.

FIG. 2 is an exemplary block diagram depicting physical components of a server according to an embodiment.

FIG. 3 is a simplified schematic view of links interconnecting pages of a website.

FIG. 4 is an exemplary block diagram depicting logical components of a web service according to an embodiment.

FIG. 5 is an exemplary block diagram illustrating the logical components of a session manager according to an embodiment.

FIGS. 6-7 are example flow diagrams depicting steps taken to implement various embodiments.

FIG. 8 is an exemplary screen view of a series of web pages supplied by a web site and accessed by a user according to an embodiment.

FIG. 9 is an exemplary view of electronic document for returning to the web site of FIG. 8 according to an embodiment.

### DESCRIPTION

Various embodiment described below operate to provide a user, upon suspension of an application session, with an electronic document containing data representative of the user's interaction with the application. The electronic document includes a link allowing the user to resume the application session at the point the application session was suspended—that is—the exit point. The electronic document can take one of many forms. One example includes an email message. Another includes a word processing document. Yet another includes a web page. This electronic document can be ported between multiple computers and multiple users. Thus, the user may end a session with a remote application, receive the electronic document, and later utilize or authorize another to utilize that document at any terminal with access to the remote application. Examining the electronic document and selecting the link, the user can resume the previously suspended application session with recollection of previous interactions.

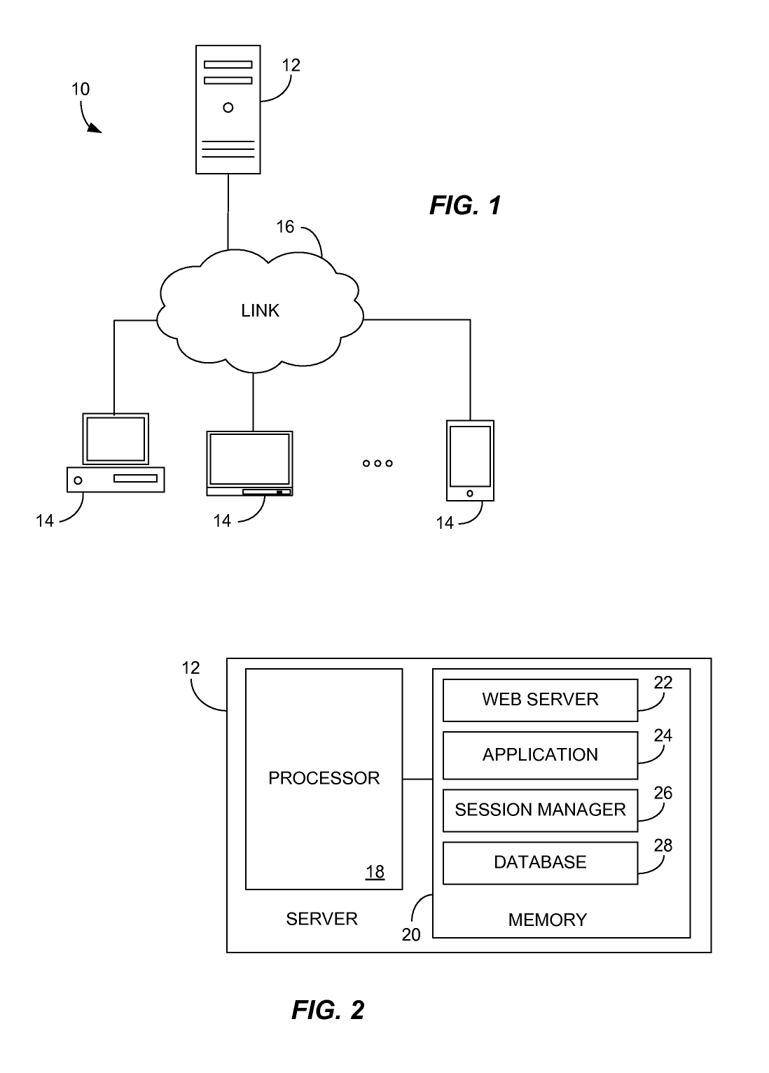

Environment: FIG. 1 depicts an exemplary environment 10 in which various embodiments may be implemented. Environment 10 is shown to include server 12, clients 14, and link 16. Server 12 represents generally any computing device capable of serving an application to clients 14. Clients 14 each represent any computing device capable of communicating with server 12 to interact with the application. Link 16 interconnects server 12 with clients 14. Link 16 represents generally one or more of a cable, wireless, fiber optic, or remote connection via a telecommunication link, an infrared link, a radio frequency link, or any other connector or system that provides electronic communication between devices 12 and 14. Link 16 may represent an intranet, the Internet, or a combination of both. The paths followed by link 16, between devices 12 and 14 in the schematic view of FIG. 1, represent the logical communication paths between these devices, not necessarily the physical paths between the devices. Devices 12 and 14 can be connected to environment 10 at any point and the appropriate communication path established logically between the devices.

Components: The logical components of various embodiments of will now be described with reference to the exemplary block diagram of FIG. 2. In this example, server 12 is shown to include processor 18 and memory 20. Processor 18 represents generally any component capable of executing program instructions stored in memory 20 to achieve a desired result. Memory 20 represents generally one or more memory units capable of storing program instructions and other data. Here, memory 20 is shown to include web server 22, application 24, session manager 26, and database 28.

Web server 22 represents generally any programming configured to serve web pages to clients 14. A user of a given client 14 may supply data or instructions through a served web page. Web server 22 is also responsible for passing such data or instructions on to their intended recipients. As discussed below, such a recipient may include application 24 and session manager 26.

Application 24 represents generally any programming for performing a specified task. In particular, application 24 is exposed to users of clients 14 via one or more web pages served by web server 22. The users submit information via those web pages to interact with and cause application 24 to perform desired tasks. As an example, application 24 may be one or more of an insurance underwriting application, an electronic commerce application, a photo printing application, and a document publishing application.

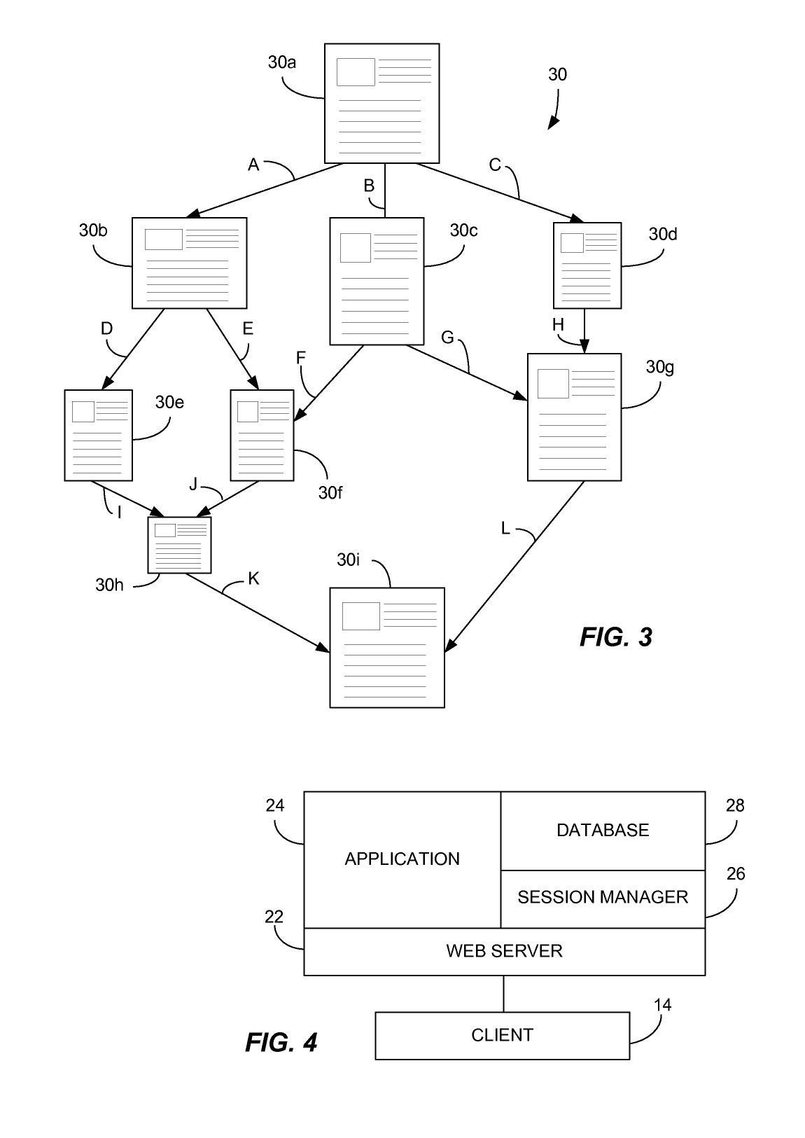

Session manager 26, discussed in more detail below, represents generally any programming capable of maintaining application state information corresponding to a user's interaction with application 22. Such application state information may, for a given user, identify the web pages accessed by that user and information supplied by the user via those web pages. Additionally, application state information may identify an exit point, that is, the particular web page being accessed by a user when that user chose to suspend interaction with application 22. In response to receiving an indication that a user has or will suspend interaction with application 22, session manager 26 is responsible for generating and providing a user with an electronic document for depicting the application state information and allowing that user to resume interaction with application 24 at the exit point. Database 28 represents generally a collection of data utilized by session manager 26 in performance of its tasks. In particular, session manager 26 utilizes database 28 to store application state information for each user. Session manager 26 also retrieves information from database 28 when generating an electronic document for depicting the state information and enabling the user to resume interaction with application 24 at an exit point. A more detailed discussion of session manager 26 and database 28 is provided below with respect to FIGS. 3-5.

FIG. 3 represents web pages 30a-30i of an exemplary website 30. With reference back to FIG. 2, web pages 30a-30i represent the vehicle through which a user interacts with application 24. As depicted, links A-L connect one web page to another. In particular, links A, B, and C connect web page 30a to web pages 30b, 30c, and 30d respectively. In a given example, page 30a is the initial page supplied by application 22, and page 30i is a final page supplied when a user has completed an application session. In this example, a user can follow a number of paths represented by links A-L to traverse website 30. One user might follow links A, E, J, K, another user may follow links C, H, L, while a third might follow links B,F,J,K.

FIG. 4 depicts the components of a web service according to an embodiment. Components 22-28, while referred to as program instructions with respect to FIG. 2, are shown here as stand-alone components. Thus, with respect to FIG. 2, each component 22-28 in FIG. 4 represents the hardware execution of the corresponding program instructions. Now, referring to FIGS. 3 and 4, to traverse web site 30, a user of client 14 initiates an application session accessing application 24 via web server 22. Application 24 supplies client 14 with web page 30a. The user makes selections or otherwise enters data through that page and selects link B causing application 24 to return web page 30c to client 14. Again the user makes selections or otherwise enters data through that page and then selects link F causing application 24 to return web page 30f. The user at this point may desire to suspend the application session. Web page 30f can be thought of as an exit point. The user, at a later time, may desire to resume the application session but may not recall the exit point or the data previously entered or selections previously made.

To assist the user in resuming the session, session manager 26 monitors the application session recording data entered and section made through the various web pages of web site 30 in database 28. In this example, those web pages include web pages 30a, 30c, and 30f. When the user provides an indication that the application is to be suspended, session manager 26 generates a link for returning the user to the exit point of the application session. Session manager 26 generates an electronic document for depicting that link and state data indicative of the application session. That state data, for example, may be content reflecting the selections made and data entered during the application session. Session manager 26 then communicates the electronic document to the user. At a later point the user displays the electronic document and views the state data to recall the prior interaction with application 24. The user then selects the link causing application 24 to resume the application session at the exit point. In this example, application 24 returns web page 30f allowing the user to finish the application session.

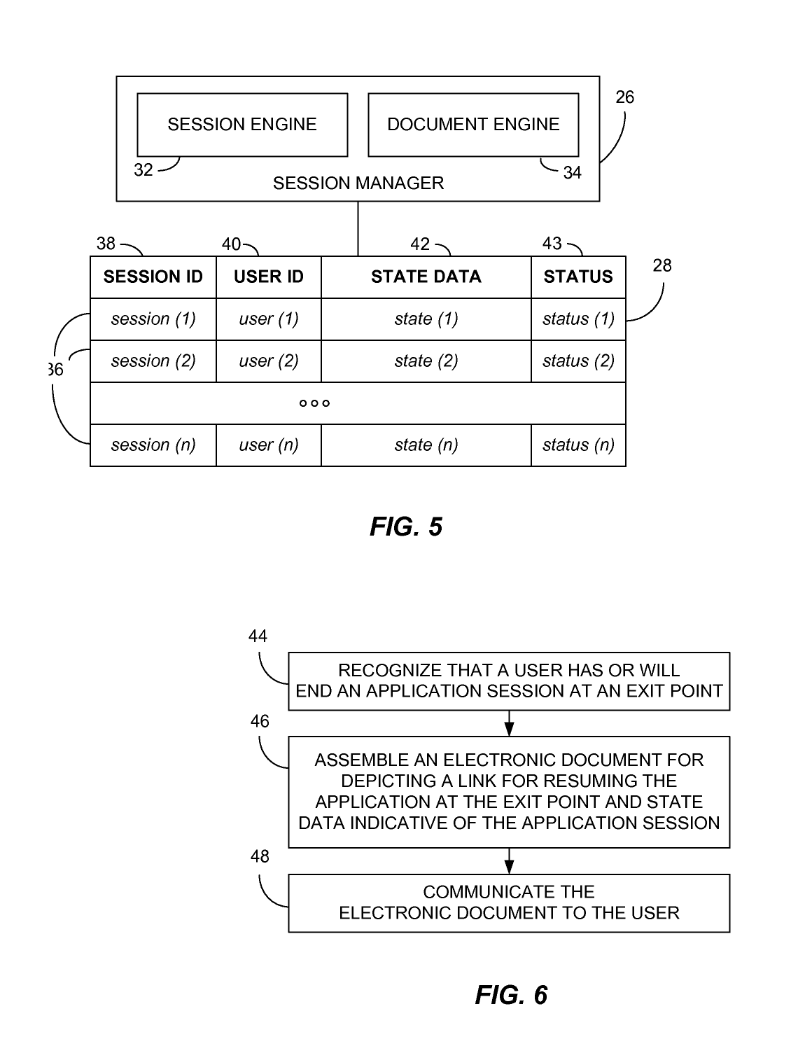

FIG. 5 is an exemplary block diagram illustrating the logical components of session manager 26 and database 28. Session manager 26 is shown to include session engine 32 and document engine 34. Session engine 32 represents program instructions configured to monitor an application session and record state data indicative of data entered and selections made by a user during the application session. Session engine 32 is also responsible for recognizing that a user has ended or will end an application session at a given exit point. In response to the suspension, session engine 32 generates a link for resuming the application session at the exit point. That link includes data such as an URL (uniform resource locator) identifying the exit point. The link includes data identifying the suspended application session. The following is an example of such a link:
www.website.com/page_n/?session_id=xyz
   The portion “www.website.com/page_n” identifies the application and the exit point. The portion “?session_id=xyz” identifies the application session with “xyz” being the session identifier. Other configurations of a link are of course also possible.

Document engine 34 represents program instructions configured to assemble an electronic document for depicting state data indicative of a suspended application session and the link for resuming the application session at the exit point. For example, document engine 34 may generate the electronic document such that when displayed, the electronic document visually depicts the link and at least a portion of the user's interactions with the application during the session as represented by the state data recorded by session engine 32. While shown as a component of session manager 26, document engine 34 may instead be an independent component or a part of application 24. Such would allow session manager 26 to remain unaware of many details of the appearance of application 24 to the user. Thus, document engine 34 could continually or periodically update the electronic document as the user interacts with application 24. Once the session is suspended, document engine 34 would insert the link generated by session engine 32 and communicate the electronic document to the user.

Database 28, in this example, is shown to include a series of entries 36. Each entry 36 corresponds to a particular application session and includes data in fields 38, 40, 42, and 43. Session ID field 38 of each given entry represents a session identifier for a given application session. User ID field 40 of each given entry 36 contains data that can be used to confirm the user's identity such as a pre-shared password. State data field 42 of each given entry 36 contains state data recorded for a particular application session. Status field 43 of a given entry contains data such as a flag indicating whether or not the application session identified by the session identifier has expired. Such may have occurred if the user previously selected the corresponding link and continued working with the application.

Following communication of the electronic document to the user, session engine 32 is responsible for receiving a request resulting from a user's selection of the link. Upon selection, data contained in the link is communicated to session engine 32. Session engine 32 uses the session identifier from the link to access an entry 36 in database 28 containing matching data in session ID field 38. From that entry 36, session engine 32 accesses data from user ID field 40 to challenge and verify the identity of the user who selected the link. Once the user's identity is verified, session engine 32 examines status field 43 to determine whether the selected link has expired. If expired, session engine 32 may simply reject the request and redirect the user to an error page. Alternatively, session engine 32 may notify the user that the link has expired and query as to whether the user desires to continue anyway.

Assuming the link has not expired or the user has chosen to continue, session engine 32 accesses the previously recorded state data found in state data field 42 and causes application 24 to resume the application session at the exit point in accordance with the accessed state data. Session engine 32 then updates status field 43 of the accessed entry 36 to identify the link as expired, monitors the resumed application session, and records state data indicative of data entered and selections made during the resumed application session in a new entry 36 of database 28. Session engine 32 may also copy or otherwise record state data from the previously accessed entry 36 in the new entry 36. Alternatively, session engine 32 may include a reference to the previously accessed entry 36 in the new entry 36. In either case, if the session is once again suspended, a new link referencing the new entry can be accessed to resume the application session.

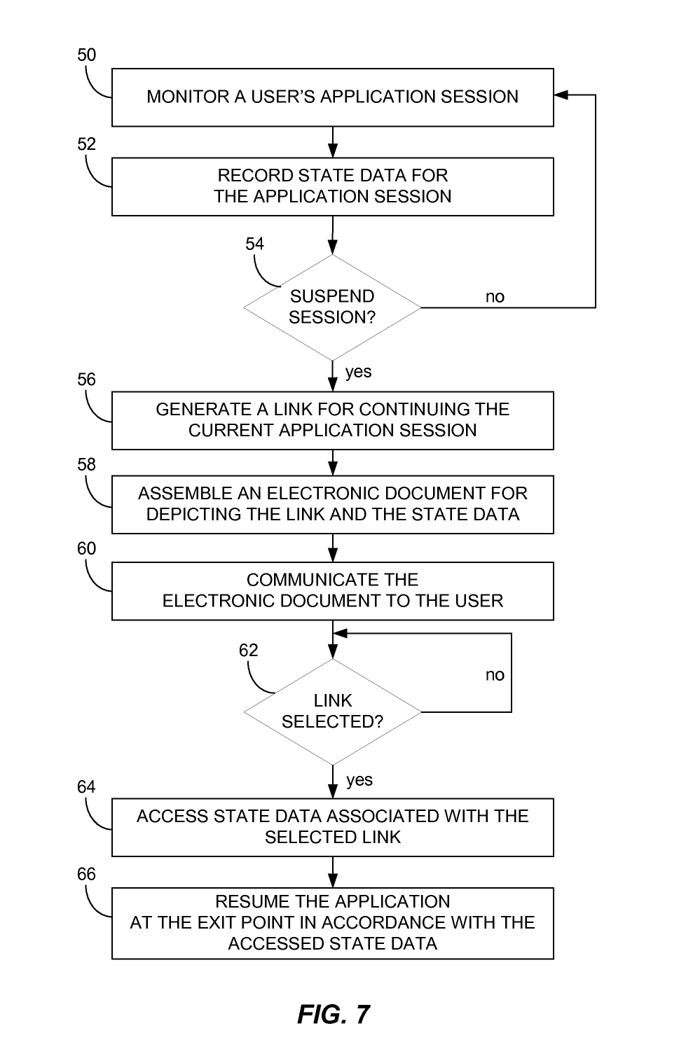

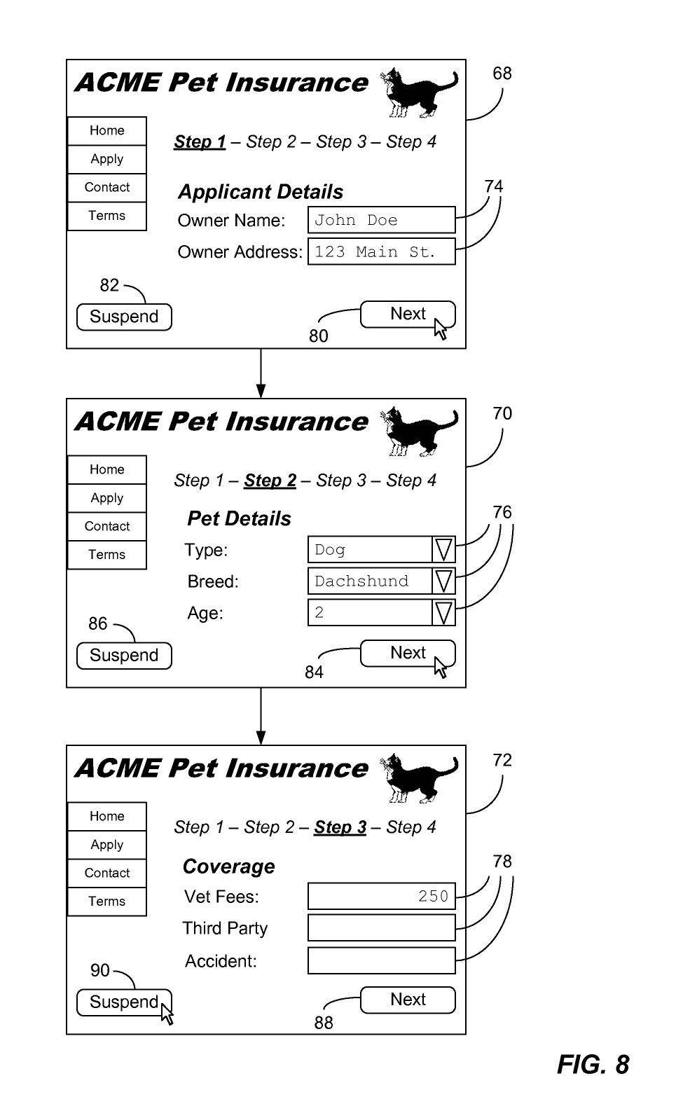

Operation: FIGS. 6 and 7 are exemplary flow diagrams illustrating steps taken to implement various embodiments. In discussing FIGS. 6 and 7, reference is made to the diagrams of FIGS. 4-5 to provide contextual examples. Implementation, however, is not limited to those examples. Starting with FIG. 6, an initial step includes recognizing that a user has ended or will end an application session at an exit point (step 44). Step 44, for example may be accomplished by session engine 32. In particular, a web page supplied by application 24 may include a user accessible control for suspending an application session. Upon activation of that control, a suspend request is communicated and recognized by session engine 32.

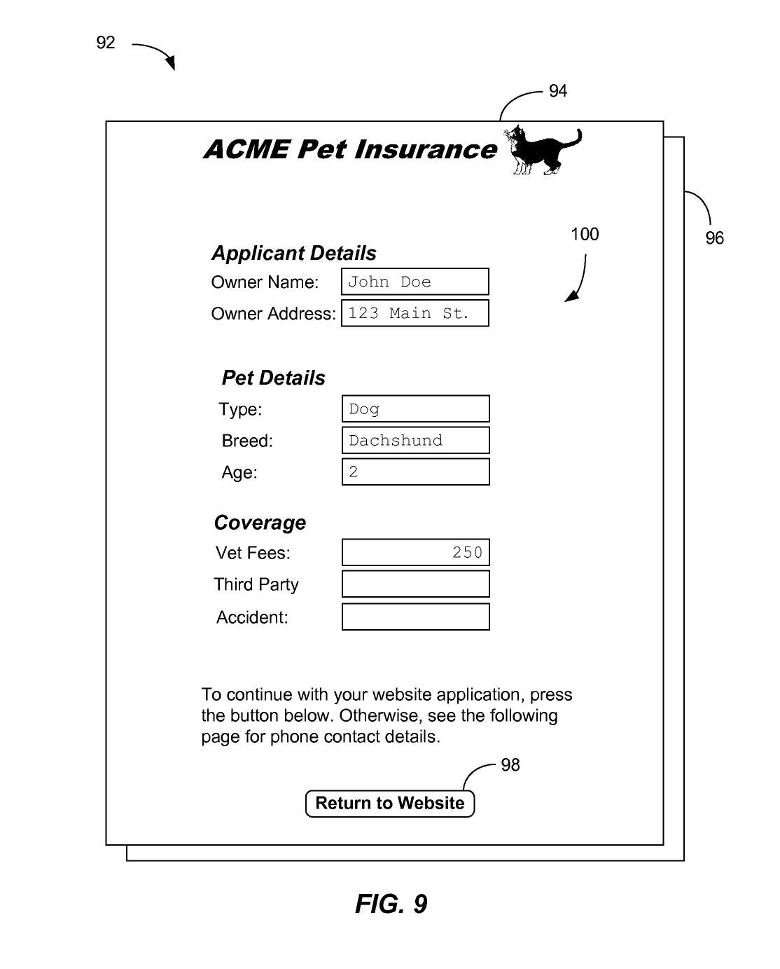

In response to the recognition in step 44, an electronic document is assembled (step 46). The electronic document is for depicting state data indicative of the application session and a link for resuming the application session at the exit point. The electronic document is communicated to the user (step 48). Referring back to FIGS. 4 and 5, document engine 34 may implement step 46 by creating an electronic document including content that when displayed provides a user discernable visual representation of the user's interactions with application 24 up to the point the application session was suspended. Document engine 34 also inserts the link into the electronic document and communicates the electronic document to the user in step 48. Step 48 may be accomplished, for example, by sending an electronic mail or returning a web page version of the electronic document. Thus, when received and displayed, the electronic document generated in step 46 depicts state data corresponding to the user's interaction with the application as well as the link. The user can save the electronic document for future use. An example is discussed below with reference to FIGS. 8 and 9.

Moving to FIG. 7, a user's application session is monitored (step 50). State data for the application session is recorded (step 52). Steps 50 and 52 may be accomplished by session engine 32. When a user establishes a new session with application 24, session engine 32 creates a new entry 36 in database 28 for that application session. As a user enters data or otherwise makes selections during the application session, session engine 32 updates the entry 36 with corresponding state data.

A determination is made as to whether a user has or intends to suspend the application session (step 54). Again, session engine 32 may be responsible for step 54. In particular, a web page supplied by application 24 may include a user accessible control for suspending an application session. Upon activation of that control, a suspend request is communicated and recognized by session engine 32. Upon recognition that the application session is to be suspended, the process continues with step 56. Otherwise, the process returns to step 50

Assuming the application session has been or is to be suspended, a link for resuming the application session is generated at an exit point (step 56). As explained above, that link can include data such as an URL (uniform resource locator) identifying the exit point. The link can also include data identifying the suspended application session. An electronic document is assembled (step 58). The electronic document is for depicting state data indicative of the application session and the link for resuming the application session at the exit point. The electronic document is communicated to the user (step 60). Referring back to FIGS. 4 and 5, document engine 34 may implement step 58 by creating an electronic document including content that when displayed provides a user discernable visual representation of the user's interactions with application 24 up to the point (the exit point) the application session was suspended. Document engine 34 also inserts the link into the electronic document and communicates the electronic document to the user in step 48.

The process pauses until the link included in the electronic document is selected (step 62). State data associated with the link is accessed (step 64), and the previously suspended application session is resumed at the exit point in accordance with the accessed state data (step 66). Referring back to FIGS. 4 and 5, upon selection of the link by a user, a request containing the contents of the link is communicated. Session engine 32 receives and parses the request to identify a session identifier. Session engine 32 accesses an entry 36 in database 28 having a matching session identifier. Using state data from the accessed entry 26, session engine 32 causes application 24 to resume the application session at the exit point.

### Example

FIG. 8 depicts exemplary screen views of an application session—that is—a user's interaction with an application. In this example, the application allows a user to enroll for pet insurance. FIG. 8 depicts three screen views 68, 70, and 72. Each screen view 68, 70, and 72 may, for example, correspond to a different web page. Screen view 68 includes controls 74 allowing a user to enter owner information. Screen view 70 includes controls 76 for entering pet information, and screen view 72 includes controls 78 for entering coverage information. In this exemplary application session a user has completed entering data in screen views 68 and 70 and has partially completed screen view 72.

Screen view 68 includes controls 80 and 82. Control 80 allows the user to move to the next screen view. Control 82 allows the user to suspend the application session. Here the user selected control 80 causing the display of screen view 70. Screen view 70 includes controls 84 and 86. Control 84 allows the user to move to the next screen view. Control 86 allows the user to suspend the application session. Here the user selected control 84 causing the display of screen view 72. Screen view 72 includes controls 88 and 90. Control 88 allows the user to move to the next screen view. Control 90 allows the user to suspend the application session. Here the user selected control 90 indicating a desire to suspend the application session.

Referring back to FIGS. 4 and 5, as the user traversed screen views 68, 70, and 72 provided by application 24, session engine 32 monitored and recorded the data entered and selections made by the user. Recognizing the user's selection of control 90 in screen view 72, session engine 32 generates a link for resuming the application session at the exit point reflected in screen view 72. Document engine 34 then assembles an electronic document for depicting the state data indicative of the user's interactions with screen views 68, 70, and 72 and the link.

FIG. 9 is an exemplary screen view of an electronic document 92 assembled by document engine 34. In the example of FIG. 9, electronic document 92 includes pages 94 and 96. Page 94 includes link 98 for resuming the application session at the exit point. Link 98 is shown as a control in which the link is embedded. Thus the actual link is not exposed to the user. Alternatively, page 96 could expose the link. Referring back to FIGS. 4 and 5, a user's selection of link 98 results in application 24 returning screen view 72 allowing the user to continue the application session. Page 94 also includes content 100 depicting the user's interactions with application 24 during the application session as represented by the state data. In other words, content 100 is indicative of the application session up to the point of suspension. Thus, the user, before resuming the application session, can review state data 100 to recall and confirm prior interactions with application 24. Page 96, while not shown, may include, among other data, contact information for continuing the application process by phone.

### CONCLUSION

The environment 10 shown in FIG. 1 is an exemplary environment in which embodiments of the present invention may be implemented. Implementation, however, is not so limited. Embodiments can be implemented in any environment in which it is desirable to interact with a remote application. The diagrams of FIGS. 2-7 show the architecture, functionality, and operation of various embodiments. Certain components are defined at least in part as a program or program instructions. Such components may represent, at least in part, a module, segment, or portion of code that comprises one or more executable instructions to implement the specified logical function(s). Such components may also represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a hard drive, a random access memory (RAM), a read-only memory (ROM), an erasable programmable read-only memory, or a portable disc.

Although the flow diagrams of FIGS. 6-7 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for capturing an application state, comprising:
recognizing that a user has ended or will end an application session at an exit point;
in response to the recognizing, assembling an electronic document for depicting state data indicative of the application session and a link for resuming the application session at the exit point; and
communicating the electronic document to the user.

2. The method of claim 1, comprising generating the link, wherein the link includes data identifying the exit point, data identifying the user, and data identifying the session.

3. The method of claim 1, wherein assembling comprises assembling an electronic document such that when displayed, the electronic document visually depicts the link and at least a portion of the user's interactions with the application during the session as represented by the state data.

4. The method of claim 1, further comprising, subsequent to communicating the electronic document:
receiving a request corresponding to a selection of the link;
accessing state data corresponding to the link; and
resuming the application at the exit point in accordance with the accessed state data.

5. The method of claim 1, further comprising, prior to recognizing:
monitoring the application session for the user; and
recording state data for the application session, the recorded state data corresponding to the state data to be depicted in the electronic document.

6. A computer readable medium having computer executable instructions thereon for implementing a method, the method comprising:
recognizing that a user has ended or will end an application session at an exit point;
in response to the recognizing, assembling an electronic document for depicting state data indicative of the application session and a link for resuming the application session at the exit point; and
communicating the electronic document to the user.

7. The medium of claim 6, wherein the method includes generating the link, wherein the link includes data identifying the exit point, data identifying the user, and data identifying the session.

8. The medium of claim 6, wherein assembling comprises assembling an electronic document such that when displayed, the electronic document visually depicts the link and at least a portion of the user's interactions with the application during the session as represented by the state data.

9. The medium of claim 8, wherein the method includes, subsequent to communicating the electronic document:
receiving a request corresponding to a selection of the link;
accessing state data corresponding to the link; and
resuming the application at the exit point in accordance with the accessed state data.

10. The medium of claim 1, wherein the method includes, prior to recognizing:
monitoring the application session for the user; and
recording state data for the application session, the recorded state data corresponding to the state data to be depicted in the electronic document.

11. A system for capturing an application state, comprising a processor and a memory, the processor configured to executing program instructions stored on the memory, the memory including program instructions that when executed cause the processor to function as a session engine and a document engine, wherein:
the session engine is configured to recognize that a user that a user has ended or will end an application session at an exit point; and
the document engine is configured to assemble and communicate an electronic document for depicting state data indicative of the application session and a link for resuming the application session at the exit point.

12. The system of claim 11, wherein the session engine is configured to generate the link, the link including data identifying the exit point, data identifying the user, and data identifying the session.

13. The system of claim 11, wherein the document engine is configured to assemble the electronic document such that when displayed, the electronic document visually depicts the link and at least a portion of the user's interactions with the application during the session as represented by the state data.

14. The system of claim 11, wherein the session engine is configured, after the end of the session, to:
receive a request corresponding to a selection of the link;
access state data corresponding to the selected link; and
resume the application at the exit point in accordance with the accessed state data.

15. The system of claim 11, wherein the session engine is operable, during the session, to:
monitor the application session for the user; and
record state data for the application session, the recorded state data corresponding to the state data to be depicted in the electronic document.
